(19) United States
(12) Patent Application Publication
(10) Pub. No.: US 2012/0298448 A1
(43) Pub. Date: Nov. 29, 2012

(54) Ladder Safety Device

(76) Inventor: Michael Houdyshell, Minden, NV (US)

(21) Appl. No.: 13/479,606

(22) Filed: May 24, 2012

Related U.S. Application Data
(60) Provisional application No. 61/490,973, filed on May 27, 2011.

(51) Int. Cl. E06C 7/18

(52) U.S. Cl. 182/106

(57) ABSTRACT

The present disclosure relates to a ladder safety device that promotes the safe use of step ladders. The ladder safety device includes a first structural component that prevents a ladder user from stepping on an upper-most step of the step ladder. The ladder safety device also includes a second structural component that prevents the user from stepping on a ladder top of the step ladder.

### CROSS-REFERENCE TO RELATED APPLICATION

The present application claims the benefit of U.S. Provisional Patent Application Ser. No. 61/490,973, filed May 27, 2011, which application is hereby incorporated by reference in its entirety.

### TECHNICAL FIELD

The present disclosure relates generally to attachments for ladders. More particularly, the present disclosure relates to attachments for a free-standing step ladder.

### BACKGROUND

FIG. 1 illustrates a typical free-standing step ladder (20). The step ladder (20) includes a front section (22) and a rear section (24). The front and rear sections (22, 24) are pivotally connected to one another adjacent a ladder top (26) of the ladder. The pivotal connection between the front and rear sections (22, 24) allows the step ladder (20) to be pivoted between a free-standing position (shown at FIG. 1) and a folded position. Collapsible braces (26) are used to retain the front and rear sections (22, 24) in the free-standing position.

Referring still to FIG. 1, the front section (22) of the ladder (20) includes spaced-apart rails (28) interconnected by steps (30) that extend between the rails (28). The rails (28) of the ladder (20) are formed by structural members in the form of c-channels. Each of the c-channels includes a base (23) and opposing front and rear flanges (25, 27) that project outwardly from the base (23) to form a generally c-shaped transverse cross section.

Falls from ladders such as free-standing step ladders are responsible for a significant number of injuries and deaths each year. To promote ladder safety, it is highly recommended for a ladder user to never stand on the ladder top (26) or on an upper-most step (31) of the ladder (20). This is recommended because if a user of a ladder stands on either the upper-most step (31) or the ladder top (26), should the user lose his or her balance, the risk of falling is extremely high since there is no portion of the ladder available to be grasped.

In view of the dangers associated with standing on the ladder top or the upper-most step of a free-standing step ladder, the Occupational Safety and Health Administration prohibits employees on the job from standing on the ladder top or the upper-most step of a free-standing step ladder (see 29 C.F.R. §1926.1053(b)(13)). If an employee is cited for violating this regulation, the employee's employer can be subject to a substantial fine.

### SUMMARY

The present disclosure relates to a device for promoting the safe usage of free-standing step ladders.

One aspect of the present disclosure relates to a ladder safety device that prevents a user from stepping on the upper-most step of a free-standing step ladder.

Another aspect of the present disclosure relates to a ladder safety device that prevents a ladder user from stepping on the ladder top of a free-standing step ladder.

A further aspect of the present disclosure relates to a ladder safety device that prevents a ladder user from stepping on both the upper-most step and the ladder top of a free-standing step ladder.

### BRIEF DESCRIPTION OF THE DRAWINGS

FIG. 1 shows a prior art step ladder;

FIG. 2 is a front view of a ladder safety device in accordance with the principles of the present disclosure;

FIG. 3 is a side view of the ladder safety device of FIG. 2;

FIG. 4 is a top view of the ladder safety device of FIG. 2;

FIG. 5 is a front view of a retainer clip of the ladder safety device of FIG. 2;

FIG. 6 is a top view of the retainer clip of FIG. 5;

FIG. 7 is a front, side perspective view of the ladder safety device of FIGS. 2-4 shown mounted on a ladder;

FIG. 8 is a front view of the ladder safety device of FIGS. 2-4 shown mounted on a ladder;

FIG. 9 is a rear view of the ladder safety device of FIGS. 2-4 shown mounted on a ladder;

FIG. 10 is a front view of another ladder safety device in accordance with the principles of the present disclosure shown mounted on a top portion of a ladder;

FIG. 11 is a perspective view of the ladder safety device of FIG. 10; and

FIG. 12 is a cross-sectional view taken along section line 12-12 of FIG. 10.

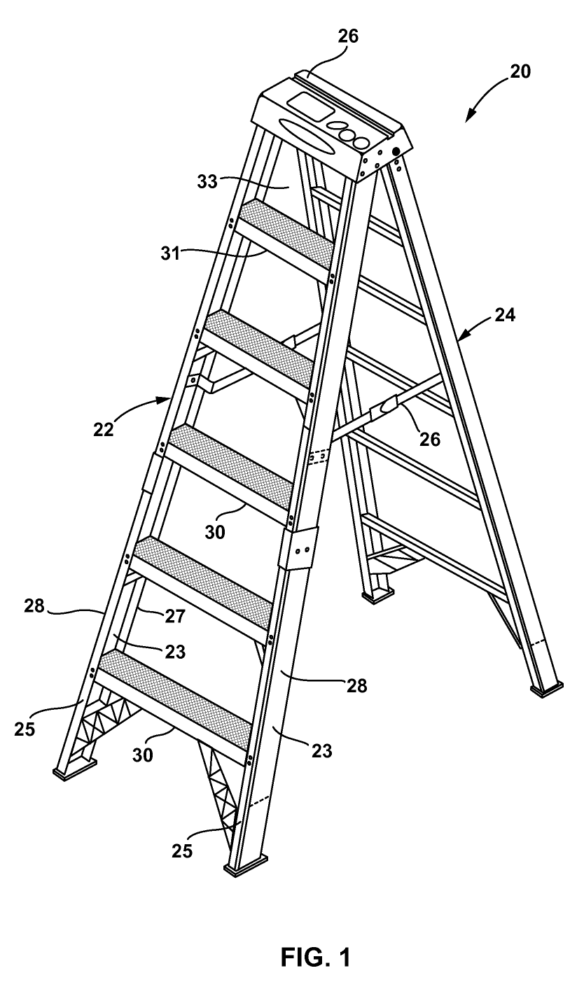

### DETAILED DESCRIPTION

Generally, the present disclosure relates to a ladder safety device that discourages or prevents ladder users from stepping on the ladder tops and upper-most steps of free-standing step ladders. In certain embodiments, the ladder safety device can be permanently fastened to the ladder or removably fastened to the ladder. In certain embodiments, the ladder safety device is configured to be mounted on ladders of various sizes and configurations provided by different ladder manufacturers. In still other embodiments, the ladder safety device can be configured for preventing people from stepping upon the ladder top while still allowing tool holders defined through the ladder top to be accessed and used.

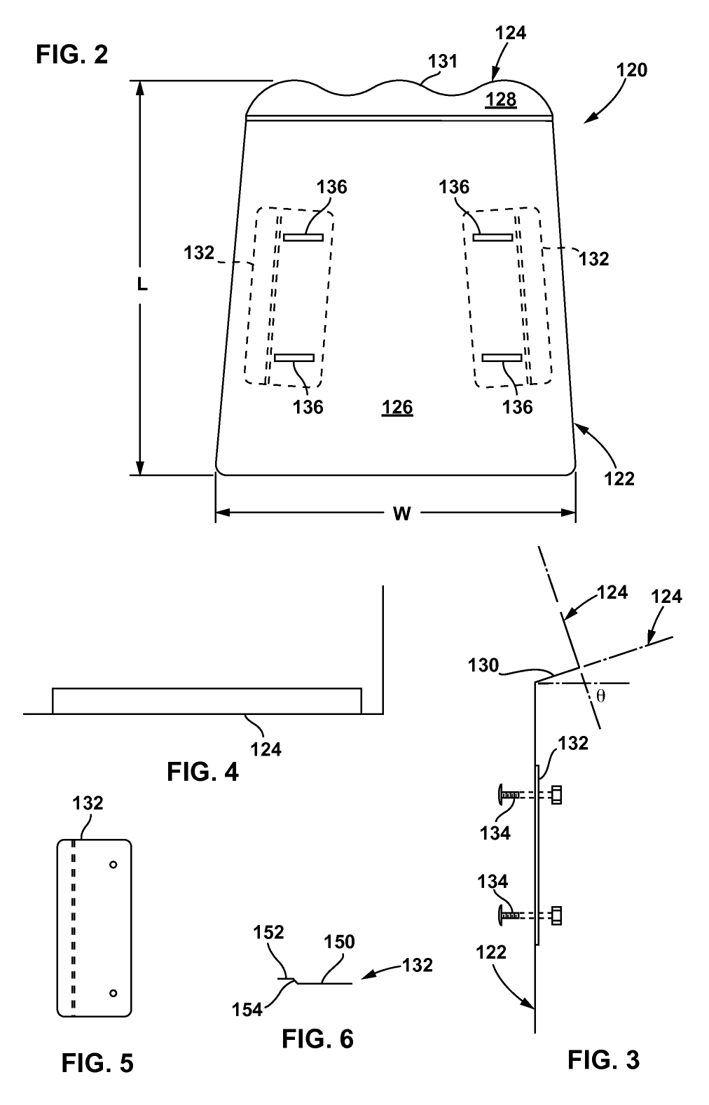

Referring to FIGS. 2-4, an example ladder safety device 120 in accordance with the principles of the present disclosure is shown. The ladder safety device 120 includes a first structural component (122) (e.g., a blocking plate, blocking member, barricading member, foot blocking member or other feature) for discouraging or preventing a ladder user from accessing or placing his or her foot on the upper-most step of a step ladder. The ladder safety device 120 also includes a second structural component (124) (e.g., a projection, flange, barrier, lip, wall or other feature) for discouraging or preventing a user of the ladder from placing his or her foot on the ladder top of a step ladder.

Referring to FIGS. 2-4, the first structural component (122) is depicted as a foot blocking plate 126 (e.g., a metal plate) sized and shaped to be mounted to the front side of the front section (22) of the ladder (20) such that an open space (33) defined between the upper-most step (31) and the ladder top (26) is at least partially blocked thereby preventing a user from placing his or her foot on the upper-most step (31). In the depicted embodiment, the foot blocking plate 126 is configured to completely cover the opening (33). Thus, a length L of the foot blocking plate (126) extends completely from the upper-most step (31) to the ladder top (26). The foot blocking plate (126) also includes a width (W) that extends completely between the rails (28) of the front section (22). The width (W) can have a tapered configuration to match the taper of the rails (28). In other embodiments, the first structural component 122 can have other configurations such as a mesh, screen, slats or other configurations suitable for providing a foot blocking or anti-stepping function.

Referring still to FIGS. 2-4, the second structural component (124) includes an anti-stepping structure such as an upwardly projecting flange (128) adapted to project upwardly from a top surface of the ladder top (26) when the ladder safety device (120) is mounted to the ladder (20). The flange (128) can project orthogonally upwardly from the top surface of the ladder top (26) or upwardly at an angle from the top surface of the ladder top (26). An inter-connect portion (130) extends from a top edge of the foot blocking plate (126) to a bottom edge of the flange (128) such that the flange (128) is connected to the plate (126). In the depicted embodiment, the plate (126), the inter-connect member (130) and the flange (128) are formed from a single piece of sheet metal bent to the desired shape. However, in other embodiments, the ladder safety device (20) can be constructed of another material such as molded plastic.

Referring to FIG. 2, a top edge (131) of the flange (128) has an undulated configuration having a series of peaks and valleys that discourage a user of the ladder from stepping thereon. As shown at FIG. 3, the flange (128) is perpendicular relative to the inter-connect piece (130) and is angled relative to a top-surface of the ladder top (26) such that the flange (128) extends forwardly and upwardly as the flange (128) extends away from the ladder top (26). The inter-connect portion (130) angles slightly upwardly as the inter-connect portion extends from the plate (126) to the flange (128). In one embodiment, the inter-connect portion defines an angle θ in the range of 60 to 80 degrees.

The distance between the upper edge of the plate (126) and the bottom edge of the flange (128) is preferably relatively short (e.g., preferably less than 2 inches, more preferably less than 1.5 inches, and most preferably about 1 inch) so that the ladder safety device (120) does not cover or otherwise block access to tool holders defined vertically through the ladder top (26).

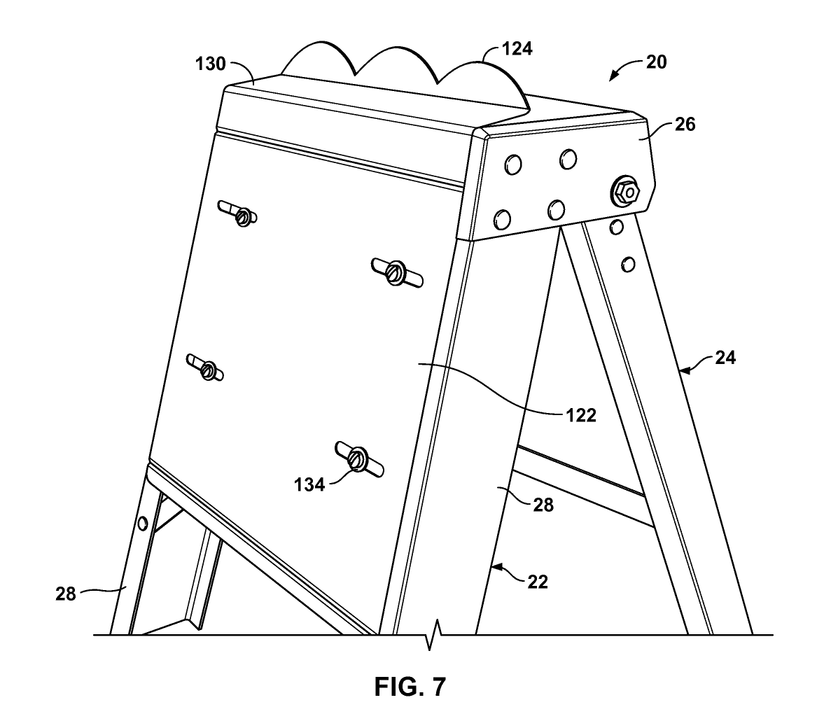

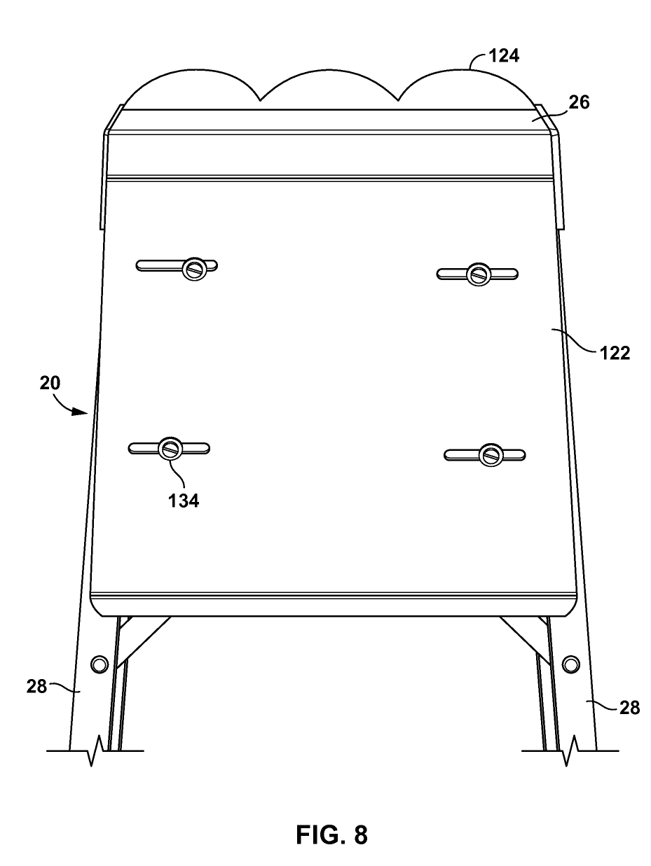

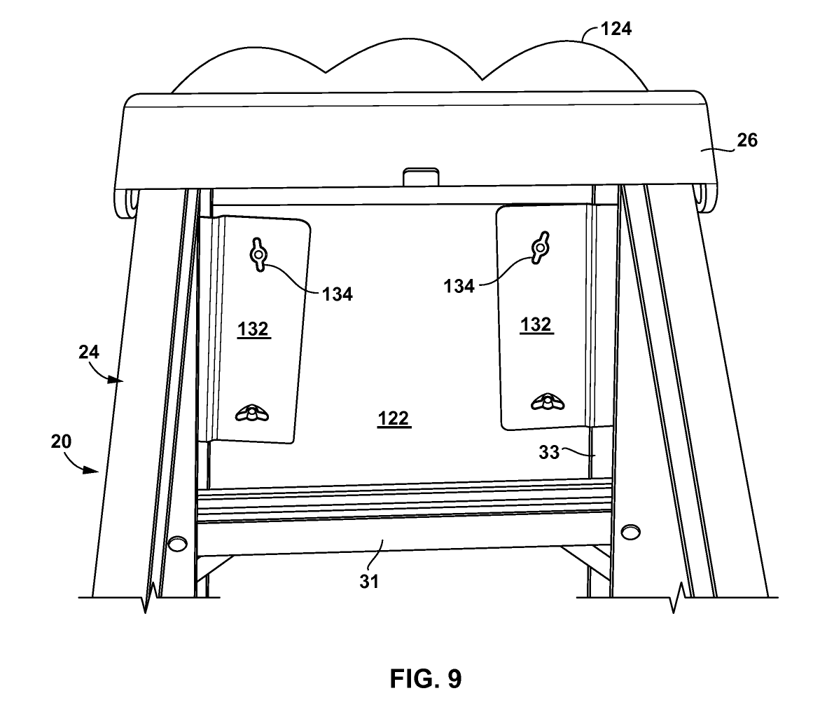

As shown in FIGS. 7-9, when the ladder safety device (120) is mounted to the ladder (20), the plate (126) abuts against front sides of the rails (28) and completely covers the opening (33) between the upper-most step (31) and the ladder top (26). Also, with the ladder safety device (120) mounted on the ladder (20), the inter-connect piece (130) extends over the top side of the ladder top and recesses the flange (128) slightly rearward of a front edge of the ladder top (26). The ladder safety device (120) is secured to the ladder (20) through the use of retainer clips (132) (e.g., clamping plates, backing plates, etc.) and fasteners (134). The fasteners (134) extend through horizontally elongated openings (136) defined through the foot blocking plate (126). The elongated configuration of the openings (136) allows the ladder safety device (20) to be readily mounted on ladders of different sizes and configurations.

When the ladder safety device (120) is secured to the ladder, the front flanges (25) of the rails (28) are clamped between the foot blocking plate (126) and the rear retainer clips (132). The rear retainer clips (132) each include a cover plate engaging portion (150) and a rail engaging portion (152) that are generally parallel. The rail engaging portion (152) and the cover engaging portion (150) are connected by an offset portion (154) that rearwardly offsets the rail engaging portion (152) from the cover engaging portion (150). The offset corresponds to a thickness of the front flange of the rail. When the ladder safety device (120) is mounted to the ladder, the fasteners (134) draw the cover engaging portions (150) of the retainer clips (132) against the backside of the foot blocking plate (126) and the front flanges of the rails (128) are captured and clamped between the rail engaging portions (152) of the retainer clips (132) and the back side of the foot blocking plate (126).

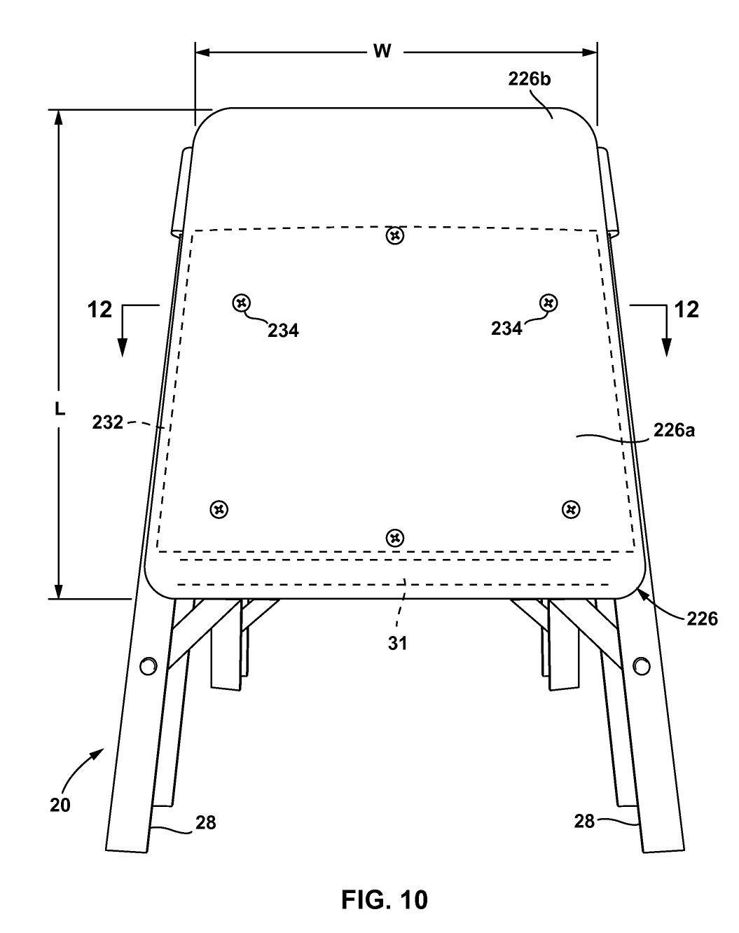

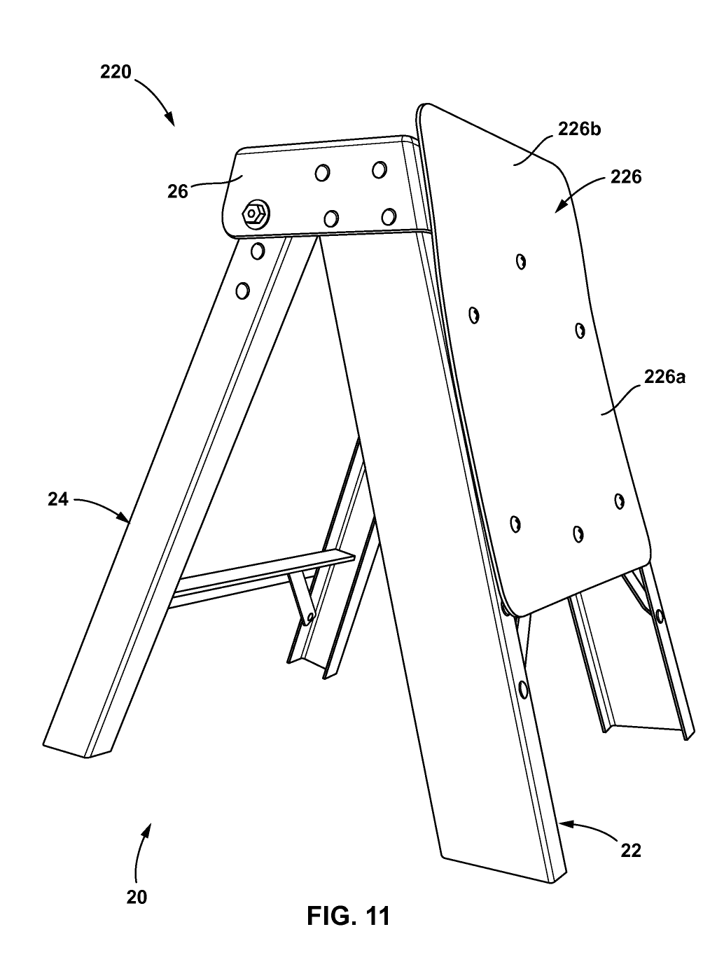

Referring to FIGS. 10-12, another ladder safety device (220) in accordance with the principles of the present disclosure is shown. The ladder safety device (220) is adapted for discouraging or preventing a ladder user from accessing or placing his/her foot on the upper-most step of a step ladder. The ladder safety device (220) is also configured for discouraging or preventing a user of the ladder from placing his/her foot on the ladder top of a step ladder. In the depicted embodiment of FIGS. 10-12, the ladder safety device (220) includes a foot blocking member such as a foot blocking plate (226) having a planar configuration. In a preferred embodiment, foot blocking plate (226) has a composite, laminated construction. For example, the foot blocking plate (226) can include a polymeric core material (227) (e.g., a high density polyethylene core) bonded between two sheets of metal material (229) such as aluminum. In a preferred embodiment, a front side of the foot blocking plate (226) can be finished with a front layer (e.g., a Kynar 500® tvdf resin-based coating) on which text can be printed. In certain embodiments, a warning or use instructions can be printed on the front side of the foot blocking plate (226). In certain embodiments, the foot blocking plate (226) can be made of a material such as ALUCOBOND® aluminum composite material sold by 3A Composites USA.

Referring to FIGS. 10-12, the foot blocking plate (226) has a planar configuration with a first portion (226a) and a second portion (226b). The first portion (226a) is sized and shaped to be mounted to the front side of the front section (22) of the ladder (20) such that the open space (33) defined between the upper-most step (31) and the ladder top (26) is at least partially blocked thereby preventing a user from placing his/her foot on the upper-most step (31). In the depicted embodiment, the lower portion (226a) of the foot blocking plate (226) is configured to completely cover the opening (33). Thus, a length (L) of the foot blocking plate (226) extends completely from the upper-most step (31) to the ladder top (26). The lower portion (226a) of the foot blocking plate (226) also includes a width (W) that extends completely between the rails (28) of the front section (22). The width (W) can have a tapered configuration to match the taper of the rails (28). In other embodiments, the foot blocking member can have other configurations such as mesh, screen, slats or other structures suitable for providing a foot blocking or anti-stepping function.

Referring still to FIGS. 10-12, the upper portion (226b) of the foot blocking plate (226) is coplanar with the lower portion (226a) of the foot blocking plate (226) and is adapted to project upwardly from a top surface of the ladder top (26) when the ladder safety device (220) is mounted to the ladder (20). The upper portion (226b) projects upwardly from the top surface of the ladder top (26) at an angle relative to the top surface of the ladder top (26). In the depicted embodiment, the upper portion (226b) angles rearwardly (e.g., inclines) as the upper portion (26b) extends in an upward direction. The rearward angle of the upper portion (226b) matches the incline angle defined by the front sides of the rails (28) of the ladder (20). In a preferred embodiment, the upper portion (226b) of the foot blocking plate (226) extends at least 0.5 inch above the top surface of the ladder top (26), or at least 0.75 of an inch above the top surface of the ladder top (26), or at least 1 inch above the top surface of the ladder top (26), or in the range of 0.5 inch to 2 inches above the top surface of the ladder top (26).

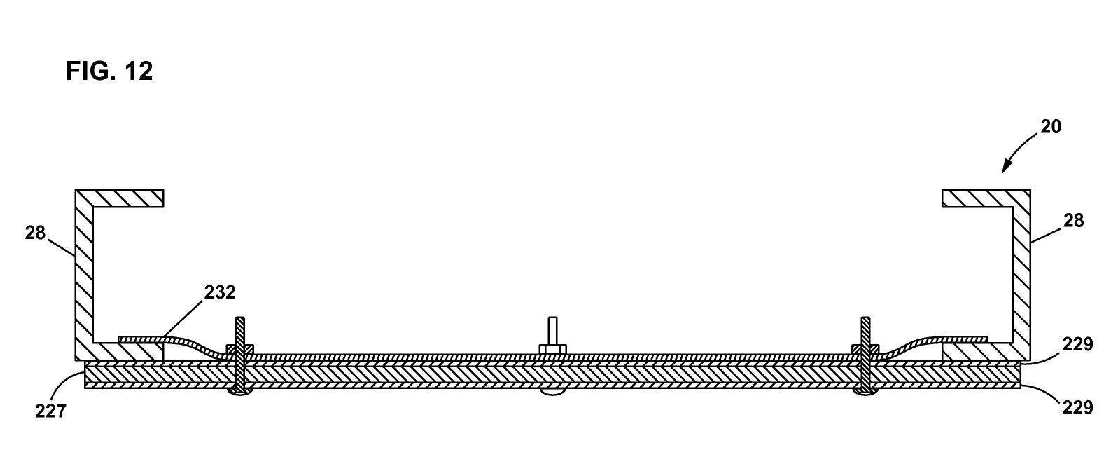

As shown at FIGS. 10-12, when the ladder safety device (220) is mounted to the ladder (20), the front blocking plate (226) abuts against front sides of the rails (28) and completely covers the opening (33) between the upper-most step (31) and the ladder top (26). As so mounted, the lower portion (226a) prevents a user from placing his/her foot in the opening (33), and the upper portion (226b) prevents a ladder user from placing his/her foot on the ladder top (26). The foot blocking plate (226) can be secured to the ladder (20) through the use of a backing plate (232) and fasteners (234). While the fasteners (234) are depicted as Phillips-head bolts, in other embodiments, the fasteners are preferably theft deterrent fasteners or other fasteners that are difficult to remove, that cannot be removed without breaking the fasteners, or that can only be removed with a special tool. As shown at FIG. 12, the fasteners (234) are used to clamp the front flanges of the rails (28) between the backing plate (235) and the foot blocking plate (226) such that the ladder safety device (220) is secured in place.

The embodiments disclosed herein are intended to illustrate without limitation the utility and scope of the present disclosure. Those skilled in the art will readily recognize various modifications and changes that may be made to the embodiments without departing from the true spirit and scope of the disclosure.

1. A ladder safety device comprising:
an anti-step structure configured to be attached to a ladder, the anti-step structure including a first structural component configured to at least partially block an open region defined between an upper-most step and a ladder top of the ladder such that a user of the ladder is prevented from stepping on the upper-most step, and a second structural component that projects upwardly from a top side of the ladder top and prevents the user from stepping on the ladder top.

2. The ladder safety device of claim 1, wherein the first structural component includes a foot blocking member adapted to be connected to opposing rails of a front section of the ladder, and the second structural component includes an anti-stepping flange configured to project upwardly from the ladder top.

3. The ladder safety device of claim 2, wherein the anti-stepping flange includes a top edge defining a plurality of undulations.

4. The ladder safety device of claim 2, wherein the foot blocking member includes a foot blocking plate adapted to cover all or substantially all of the open space defined between the upper-most step and the ladder top of the ladder.

5. The ladder safety device of claim 2, wherein the anti-stepping flange is positioned within two inches of the front edge of the ladder top.

6. The ladder safety device of claim 2, wherein the anti-stepping flange angles forwardly and upwardly relative to the ladder top.

7. The ladder safety device of claim 1, wherein the anti-step structure comprises a planar foot blocking member, wherein the first structural component comprises a lower portion of the planar foot blocking member and wherein the second structural component comprises an upper portion of the planar foot blocking member.

8. The ladder safety device of claim 7, wherein the upper portion of the planar foot blocking member projects at least 0.5 inch above a top side of the ladder top.

9. The ladder safety device of claim 7, wherein the upper portion of the planar foot blocking member projects a distance in the range of 0.5 inch to 2 inches above a top side of the ladder top.

10. The ladder safety device of claim 7, wherein the upper portion of the planar foot blocking member projects at least 0.75 of an inch above a top side of the ladder top.

11. The ladder safety device of claim 7, wherein the foot blocking member comprises a foot blocking plate having a composite construction.

12. The ladder safety device of claim 11, wherein the foot blocking plate includes a polymeric core bonded between two metal layers.
